(19) United States
(12) Patent Application Publication
(10) Pub. No.: US 2019/0283554 A1
(43) Pub. Date: Sep. 19, 2019

(54) Security System Having A Transparent Pane Device

(71) Applicant: PR Germany GmbH, Koln (DE)

(72) Inventor: Peter Reinecke, Numbrecht (DE)

(21) Appl. No.: 16/083,612

(22) PCT Filed: Mar. 6, 2017
(86) PCT No.: PCT/EP2017/055133

§ 371 Date: Jun. 10, 2019

(30) Foreign Application Priority Data
Mar. 11, 2016 (DE) 10 2016 204 082.0

(51) Int. Cl. B60J 3/04; F41H 5/04

(52) U.S. Cl. CPC B60J 3/04; B32B 17/10055; F41H 5/0407

(57) ABSTRACT

The invention relates to a security system (1) having a transparent pane device (2). The transparent pane device (2) is designed, for example, as a window of a room of a building or as a window of a transportation means. The security system (1) has a liquid crystal film (3) with an adjustable transparency, wherein the liquid crystal film (3) is arranged on the transparent pane device (2) and/or at a distance to the transparent pane device (2). A sensor unit (4, 5, 7A to 7E) is designed to emit a sensor signal. The sensor unit (4, 5, 7A to 7E) is arranged on the transparent pane device (2). In addition, a control device (8) is provided for adjusting the transparency of the liquid crystal film (3) in accordance with the sensor signal.

The invention relates to a safety system having a transparent pane device. The transparent pane device is embodied, for example, as a window of a space of a building or as a window of a transport means. The transport means is in particular embodied as a motor vehicle, as an aircraft, as a ship or as a rail vehicle.

Known from the prior art is a laminated safety glass (LSG), which is embodied such that it resists great impact forces and/or is destroyed under a great impact force in a manner such that safety measures come into effect. Known from the prior art is for example a safety system having a transparent pane device which is made of laminated safety glass. The laminated safety glass has an intermediate layer sandwiched between a first glass pane, which is for example formed from toughened safety glass, and a second glass pane, which is likewise formed for example from toughened safety glass. Embedded in the intermediate layer is a thin wire in the form of an electrical conductor loop. The electrical conductor loop is often also referred to as an alarm spider, since the formation of the electrical conductor loop resembles the shape of a spider's web. Current flows through the electrical conductor loop. If the transparent pane device is destroyed due to the impact of a force on the transparent pane device, the first glass pane and/or the second glass pane shatter, which destroys the electrical conductor loop and interrupts the circuit. In this way, an intruder alarm system provided at the safety system is activated and an alarm is triggered.

Furthermore known from the prior art is a safety system having a laminated safety glass, wherein the safety system is used in particular for personal protection. The laminated safety glass of this known safety system is configured such that the laminated safety glass withstands the effects caused by punches, arms fire and/or explosions. This is attained for example by way of the thickness of the glass panes and/or by way of a special form of the intermediate layer between two glass panes, which will be explained in more detail further below. For example, this known safety system is used to secure display windows, vehicles and/or office spaces.

Known from the prior art is moreover a liquid-crystal film having liquid crystals. Liquid crystals are also increasingly used in glass element engineering nowadays. For example, a glass element is known from the prior art, which is provided with a liquid-crystal film. The liquid-crystal film, for example, is arranged between a first glass pane and a second glass pane. By applying a voltage to the liquid-crystal film, poles of liquid crystals of the liquid-crystal film align in such a way that the liquid-crystal film becomes transparent. In other words, the liquid-crystal film becomes clear upon the application of the voltage. If no voltage is applied, the liquid crystals have a random orientation. Light that is incident in the liquid-crystal film therefore is strongly diffused. The liquid-crystal film becomes opaque (“frosted”). As a consequence, the liquid-crystal film is non-see-through, i.e. not transparent. It is therefore possible to render a glass element (e.g. a glass window or glass door) that is provided with the liquid-crystal film see-through by applying a voltage or non-see-through by switching off the voltage.

The invention is based on the object of improving a safety system of the prior art to the effect that, in the case of danger or imminent danger, an object to be protected and/or a person to be protected is easier to protect.

According to the invention, this object is achieved by a safety system having the features of claim 1 or 14. A method according to the invention, in which the safety system according to the invention is employed, is provided by the features of claim 15. Further features of the invention can be gathered from the following description, the appended claims and/or the appended drawings.

The safety system according to the invention has at least one transparent pane device. The transparent pane device is for example embodied as a glass element. The glass element is embodied for example as a glass window or as a glass door. The transparent pane device is bullet-proof, impact-resistant and/or resistant to explosion effects. In this respect, the transparent pane device in one exemplary embodiment of the invention has, for example, a thickness of several centimeters, for example of 3 cm to 20 cm. This thickness is attained for example by adhesively bonding together a plurality of glass panes. In a further exemplary embodiment, provision is additionally or alternatively made for a film made from a thermoplastic to be arranged between two glass panes, which is available for example under the trademark SENTRYGLAS by DuPont. This film is considerably stronger and stiffer than other films (for example those made of polyvinyl butyral or ethylene vinyl acetate). Using this film therefore allows the use of such glass panes for the transparent pane device that are thinner and consequently also more lightweight as compared to other exemplary embodiments, but which nevertheless render the transparent pane device sufficiently bullet-proof, impact-resistant and/or resistant to explosion effects.

However, reference is explicitly made to the fact that the invention is not limited to the use of glass elements. Rather, the invention is suitable for the use of any transparent element, for example a transparent plastics element, in particular a plexiglass element.

Moreover, the safety system according to the invention has at least one liquid-crystal film having a settable transparency. For example, the liquid-crystal film can adopt a first transparency state and a second transparency state. In the first transparency state, the liquid-crystal film is, for example, transparent or nearly transparent. In the second transparency state, the liquid-crystal film is, for example, non-see-through. The liquid-crystal film is arranged at the transparent pane device and/or at a distance from the transparent pane device. For example, provision is made in one embodiment of the safety system according to the invention for the liquid-crystal film to be applied directly on the transparent pane device. In yet a further exemplary embodiment of the safety system according to the invention, provision is additionally or alternatively made for the liquid-crystal film to be arranged at a distance from the transparent pane device. For example, the distance of the liquid-crystal film from the transparent pane device is a few millimeters, for example up to 15 mm. In yet a further exemplary embodiment of the invention, the distance of the liquid-crystal film from the transparent pane device is a few centimeters, for example up to 15 cm, up to 30 cm or up to 50 cm. However, the invention is not limited to the distances mentioned. Rather, any suitable distance between the transparent pane device and the liquid-crystal film is utilizable.

Light rays that are incident on the transparent pane device transmit through the transparent pane device and through the liquid-crystal film. In other words, the transparent pane device and the liquid-crystal film are arranged with respect to one another such that light rays that are incident on the transparent pane device transmit through the transparent pane device and through the liquid-crystal film. In other words yet again, first arranged in the light incidence direction is the transparent pane device and then the liquid-crystal film. If the safety system is used to secure a space, then, in the case that the liquid-crystal film is transparent or at least partially transparent, light travels through the transparent pane device and through the liquid-crystal film into the space that is located behind the liquid-crystal film.

The safety system according to the invention furthermore has at least one sensor unit for emitting a sensor signal, wherein the sensor unit is arranged at the transparent pane device. The sensor unit as mentioned above and below is understood to mean a unit that is capable of qualitatively or quantitatively detecting, in the form of a measurement variable, physical properties, chemical properties and/or a material-related property of the environment of the sensor unit. The sensor unit produces and emits the sensor signal in dependence on the detected measurement variable. In one exemplary embodiment of the safety system according to the invention, provision is made for the sensor unit to be arranged directly on the transparent pane device. In other words, the sensor unit in this exemplary embodiment is physically connected to the transparent pane device.

Moreover, the safety system according to the invention has at least one control device for setting the transparency of the liquid-crystal film in dependence on the sensor signal. The control device is provided in particular for supplying the liquid-crystal film with a supply voltage that is used for the alignment of the liquid crystals. Accordingly, the sensor signal of the sensor unit is passed to the control device. The control device then selects the transparency of the liquid-crystal film to be set and accordingly actuates the liquid-crystal film in dependence on the senor signal. For example, the control device switches the liquid-crystal film such that said liquid-crystal film adopts the second transparency state. In the second transparency state, the liquid-crystal film is non-see-through, for example.

The safety system according to the invention has the advantage that, if danger or imminent danger is ascertained, the sensor unit can emit a sensor signal to the control device such that the control device actuates the liquid-crystal film such that the liquid-crystal film becomes non-see-through. In all these cases, provision is made for example for a control voltage (that is to say the supply voltage) of the liquid-crystal film to be switched off, such that the latter becomes non-see-through. In this way, the view through the liquid-crystal film into a space that is located behind the liquid-crystal film and/or to an object that is located behind it is blocked. Third parties are consequently unable to view the object that is located behind the transparent pane device or the space that is located behind the transparent pane device. As a consequence, the safety for example of persons situated in the space is increased. The invention is suitable in particular for protecting persons and objects against arms fire or explosion effects, in particular effects of shrapnel. As soon as arms fire and/or an effect of shrapnel is/are ascertained by the sensor unit, the control device will actuate the liquid-crystal film such that the liquid-crystal film becomes non-see-through. Switching the liquid-crystal film to a non-see-through state also occurs for example when the sensor unit detects an interruption of the general supply of voltage to the liquid-crystal film. Consequently, if there is a general power failure, for example, the liquid-crystal film in the invention is switched to a safety mode, specifically the second transparency state in which the liquid-crystal film becomes non-see-through.

In one embodiment of the safety system according to the invention, provision is additionally or alternatively made for the transparency of the liquid-crystal film to be able to be brought into a desired state, for example into the above-mentioned first transparency state or into the above-mentioned second transparency state, by way of operating the control device. In other words, the control device has an input device with which a desired transparency state of the liquid-crystal film is settable. This is an advantage in particular when a user wishes not to be disturbed and/or intends to block the view into a space from the start.

The sensor unit can comprise any type of sensor. Some sensor types that can be used for example in the invention will be explained below.

In a further embodiment of the safety system according to the invention, provision is thus additionally or alternatively made for the sensor unit to comprise at least one electrical conductor loop. The electrical conductor loop is for example embodied as a thin wire. In yet a further exemplary embodiment, provision is made for the electrical conductor loop to have the shape of a spider's web. Current flows through the electrical conductor loop. If the transparent pane device is destroyed due to the impact of a force on the transparent pane device, the electrical conductor loop is destroyed and the circuit is interrupted. In this way, the sensor signal is triggered and the liquid-crystal film is actuated by the control device such that it becomes non-see-through, for example. Provision is additionally made for an alarm notification system, which is provided at the safety system, to be activated and for an alarm to be triggered.

In a further embodiment of the safety system according to the invention, provision is additionally or alternatively made for the sensor unit to comprise at least one light sensor. Provision is made for example for the light sensor to be embodied as a CCD sensor, as a photodiode, as a phototransistor or as a photoresistor. Such an embodiment is advantageous in particular should the transparent pane device take arms fire and target acquisition and/or a distance measurement using a light beam, in particular a laser beam, be ascertained. As soon as such a light beam is detected by the sensor unit, the sensor signal is emitted by the light sensor to the control device. The control device immediately actuates the liquid-crystal film such that it becomes non-see-through, for example. In addition, provision is made in a further exemplary embodiment of the safety system according to the invention for an alarm notification system, which is provided at the safety system, to be activated and an alarm to be triggered.

In yet a further exemplary embodiment of the safety system according to the invention, provision is additionally or alternatively made for the sensor unit to comprise at least one shock sensor. The shock sensor is embodied for example as an acceleration sensor. This exemplary embodiment has the advantage that, if a force impacts the transparent pane device, for example due to shooting of a bullet and/or due to shrapnel from an explosion, the sensor unit can detect this and emits the corresponding sensor signal to the control device. The control device in turn actuates the liquid-crystal film such that the liquid-crystal film becomes non-see-through, for example. In addition, provision is also made in this exemplary embodiment of the safety system according to the invention for an alarm notification system, which is provided at the safety system, to be activated and an alarm to be triggered.

In an exemplary embodiment of the safety system according to the invention, provision is additionally or alternatively made for the transparent pane device to be formed partially from glass or entirely from glass. In yet a further exemplary embodiment of the safety system according to the invention, provision is made for the transparent pane device to be formed partially from plastics or entirely from plastics.

In an exemplary embodiment of the safety system according to the invention, provision is made for the transparent pane device to include a laminated safety glass, comprising a first glass pane and a second glass pane, wherein arranged between the first glass pane and the second glass pane is at least one film unit made from polyvinyl butyral and/or ionoplast. Ionoplast is an ionomer that is formed from ethylene and methacrylic acid. The film unit is formed for example from a film material that is sold under the trademark SENTRYGLAS by the company DuPont. The advantages of using this film material have already been explained above. However, reference is explicitly made to the fact that the invention is not limited to this type of film unit. Rather, the invention allows the use of any film unit that is suitable for the invention. For example, film units made of ethylene vinyl acetate can also be used.

In yet a further embodiment of the safety system according to the invention, the transparent pane device has a laminated safety glass device. The laminated safety glass device includes at least one first glass pane, at least one second glass pane and at least one third glass pane. Arranged between the first glass pane and the second glass pane is at least one first film unit made of polyvinyl butyral and/or ionoplast. Arranged between the second glass pane and the third glass pane is furthermore at least one second film unit made of polyvinyl butyral and/or ionoplast. By way of example, the first film unit and/or the second film unit is/are formed from a film material that is sold under the trademark SENTRYGLAS by the company DuPont. The advantages of using this film material have already been explained above. In yet a further exemplary embodiment of the safety system according to the invention, provision is made for the second film unit to comprise at least two films which are arranged parallel with respect to one another. In yet a further exemplary embodiment, the second film unit comprises at least four or at least six films which are arranged parallel with respect to one another. However, the invention is not limited to the above-mentioned number of films, which are arranged in parallel with respect to one another. Rather, any number of films, which are arranged parallel with respect to one another, can be provided for the invention, if it is suitable for the invention.

In a further exemplary embodiment of the safety system according to the invention, provision is additionally or alternatively made for the control device to have a first switch state and a second switch state. The sensor unit has, at a switch output of the sensor unit, a first sensor signal for the first switch state or a second sensor signal for the second switch state. The liquid-crystal film is embodied to be non-see-through in the second switch state. Accordingly, the second transparency state is achieved by way of the second switch state.

The invention also relates to a further safety system, which can have for example at least one of the features mentioned further above or below, or a combination of at least two of the features mentioned further above or below. The further safety system has at least one transparent pane device. The transparent pane device is embodied for example as a glass element. The glass element is embodied for example as a glass window or as a glass door. However, reference is explicitly made to the fact that the invention is not limited to the use of glass elements. Rather, the invention is suitable for the use of any transparent element, for example a transparent plastics element, in particular a plexiglass element.

Moreover, the further safety system according to the invention has at least one liquid-crystal film having a settable transparency. For example, the liquid-crystal film can adopt a first transparency state and a second transparency state. In the first transparency state, the liquid-crystal film is for example transparent or nearly transparent. In the second transparency state, the liquid-crystal film is non-see-through, for example. The liquid-crystal film is arranged at the transparent pane device and/or at a distance from the transparent pane device. Light rays that are incident on the transparent pane device transmit through the transparent pane device and through the liquid-crystal film. The further safety system furthermore has at least one sensor unit for emitting a sensor signal, wherein the sensor unit is arranged at the transparent pane device. Moreover, the further safety system includes at least one control device for setting the transparency of the liquid-crystal film in dependence on the sensor signal. The control device is provided in particular to supply the liquid-crystal film with a supply voltage, which is used for the alignment of the liquid crystals. Accordingly, the sensor signal of the sensor unit is passed to the control device. The control device then selects, in dependence on the sensor signal, the transparency of the liquid-crystal film to be set and accordingly actuates the liquid-crystal film. For example, the control device switches the liquid-crystal film such that the liquid-crystal film adopts the second transparency state. In the second transparency state, the liquid-crystal film is non-see-through, for example.

The invention also relates to a method for securing a space using a safety system having one of the features mentioned further above or below, or a combination of at least two of the features mentioned further above or below. The space for example is an interior space in a building or vehicle. The method according to the invention provides for a property to be detected by the sensor unit. This is for example a shock, a destruction of the transparent pane device and/or light incidence from a laser measuring device or a laser targeting device. If this property is detected, a sensor signal is produced. The sensor signal is passed to the control device. The control device sets the transparency of the liquid-crystal film in dependence on the sensor signal. Provision is made in particular for the setting of the transparency to be effected such that the liquid-crystal film becomes non-see-through.

The invention will be explained in more detail below with reference to exemplary embodiments. In the figures

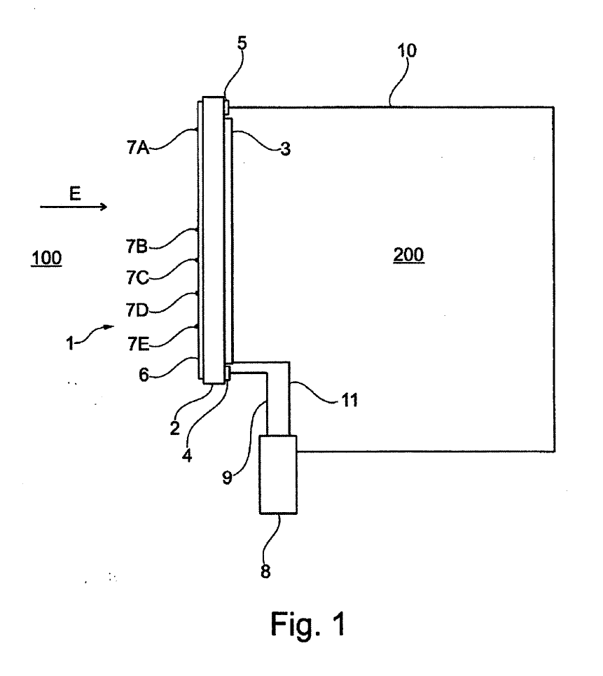

FIG. 1 shows a schematic illustration of a first embodiment of a safety system according to the invention;

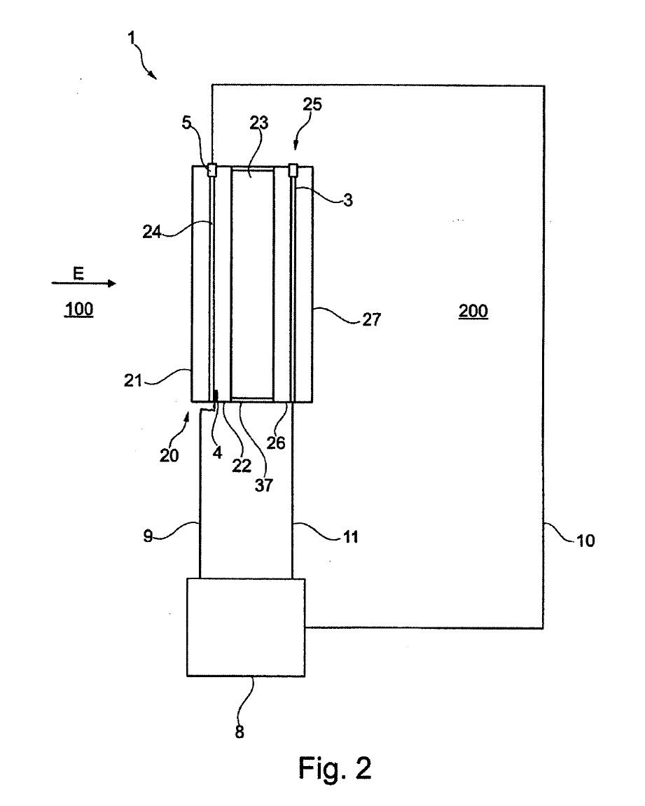

FIG. 2 shows a schematic illustration of a second embodiment of a safety system according to the invention;

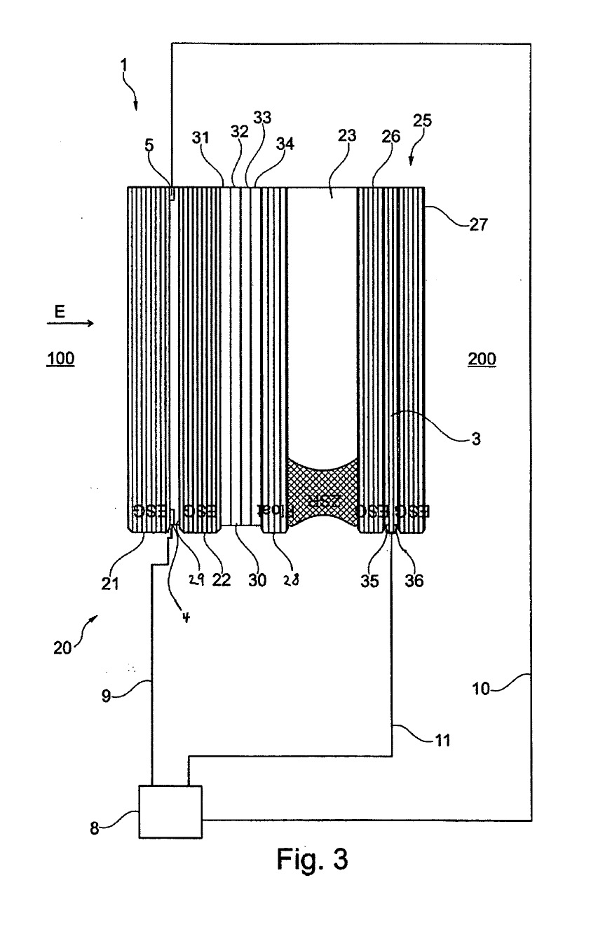

FIG. 3 shows a schematic illustration in the form of a sectional view of part of a third embodiment of a safety system according to the invention; and

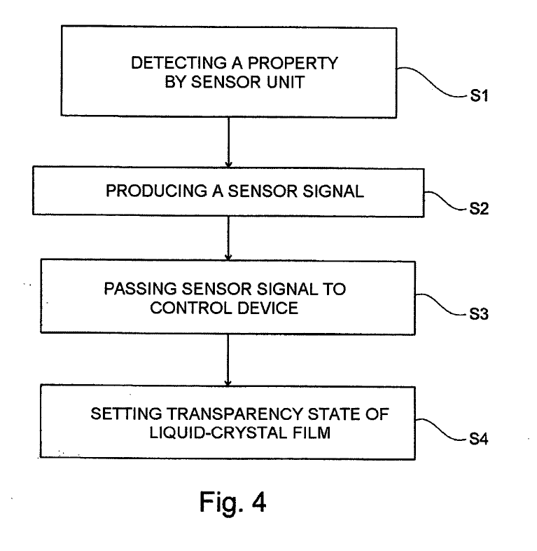

FIG. 4 shows a schematic flowchart of an embodiment of the method according to the invention.

FIG. 1 shows a schematic illustration of a first embodiment of the safety system 1 according to the invention, which separates an exterior region 100 from an interior space 200. The interior space 200, for example, is a space of a building or of a transport means. The transport means is in particular embodied as a motor vehicle, as an aircraft or as a ship.

The safety system 1 has a transparent pane device 2, which is formed from glass, for example. In the exemplary embodiment illustrated in FIG. 1, the transparent pane device is embodied as a toughened safety glass. Alternatively or additionally, the transparent pane device 2 can also be made from plastics, for example from plexiglass.

The transparent pane device 2 can, in a further embodiment, be embodied to be bullet-proof, impact-resistant and/or resistant to explosion effects. To this end, the transparent pane device 2 has, for example, a thickness of a few centimeters, for example 3 cm to 30 cm. This thickness is attained, for example, by a plurality of glass panes being adhesively bonded together.

The transparent pane device 2 has two sides. A first side faces the exterior region 100. A second side of the transparent pane device 2 faces the interior space 200. Arranged on the second side is a liquid-crystal film 3. Also arranged on the second side is a sensor unit which has for example an electrical conductor loop 4 and/or a shock sensor 5. The electrical conductor loop 4 is connected to a control device 8 via a first connecting line 9. The shock sensor 5 is connected to the control device 8 via a second connecting line 10. Moreover, the liquid-crystal film 3 is connected to the control device 8 via a third connecting line 11. The control device 8 is provided to supply the liquid-crystal film 3 with a supply voltage, wherein the supply voltage is used for the alignment of the liquid crystals.

Applied on the first side of the transparent pane device 2 is a film 6 made of polyvinyl butyral (PVB), in which, additionally or alternatively to the already above-mentioned sensors, light sensors 7A to 7E are arranged, specifically a first light sensor 7A, a second light sensor 7B, a third light sensor 7C, a fourth light sensor 7D and a fifth light sensor 7E.

The liquid-crystal film 3 in the embodiment of the safety system 1 illustrated here is arranged directly on the transparent pane device 2. In further embodiments, a further film unit is arranged between the transparent pane device 2 and the liquid-crystal film 3, for example a film unit made from PVB. This will be explained in more detail further below.

Light rays that are incident on the transparent pane device 2 transmit through the transparent pane device 2 and through the liquid-crystal film 3. In other words, first arranged in a light incidence direction E is the transparent pane device 2 and then the liquid-crystal film 3.

The liquid-crystal film 3 exhibits a settable transparency. For example, the liquid-crystal film 3 can adopt a first transparency state and a second transparency state. In the first transparency state, the liquid-crystal film 3 is, for example, transparent or nearly transparent. In the second transparency state, the liquid-crystal film 3 is, for example, non-see-through. The transparency states are actuated via the control device 8. By applying a voltage to the liquid-crystal film 3, poles of liquid crystals of the liquid-crystal film 3 align such that the liquid-crystal film 3 becomes transparent and thus adopts the first transparency state. If no voltage is applied, the liquid crystals have a random orientation. Light that is incident in the liquid-crystal film 3 is therefore strongly diffused. The liquid-crystal film 3 then becomes opaque. It is consequently non-see-through, that is to say not transparent. This is the second transparency state.

The electrical conductor loop 4 is formed as a thin wire. It has the shape of a spider's web. Current flows through the electrical conductor loop 4. If the transparent pane device is destroyed by way of the impact of a force on the transparent pane device 2 (for example by arms fire and/or due to shrapnel from an explosion), the electrical conductor loop 4 is destroyed and the circuit is interrupted. The interruption of the circuit is detected by the control device 8 via the first connecting line 9. The control device 8 then actuates the liquid-crystal film 3 in a manner such that the liquid-crystal film 3 becomes non-see-through. Consequently, the voltage that has been applied to the liquid-crystal film 3 is switched off. Provision is additionally made in this embodiment for an alarm notification system (not illustrated), which is provided at the safety system 1, to be activated and for an alarm to be triggered.

As already mentioned, provision is additionally or alternatively made for a shock sensor 5 to be arranged at the safety system 1. The shock sensor 5 is embodied for example as an acceleration sensor. Upon the impact of force on the transparent pane device 2, for example due to being shot at with a bullet and/or due to shrapnel from an explosion, the shock sensor 5 detects said impact and produces a corresponding sensor signal, which it passes on to the control device 8 via the second connecting line 10. The control device 8 in turn controls the liquid-crystal film 3 in a manner such that the liquid-crystal film 3 becomes non-see-through. Accordingly, the voltage for supplying the liquid-crystal film 3 is switched off. Provision is additionally made in this embodiment for an alarm notification system (not illustrated), which is provided at the safety system 1, to be activated and for an alarm to be triggered.

The light sensors 7A to 7E are embodied for example as a CCD sensor, a photodiode, a phototransistor or a photoresistor. If target acquisition and/or a distance measurement by way of a light beam, in particular a laser beam, is/are underway, this is ascertained using at least one of the light sensors 7A to 7E. As soon as such a light beam is detected by at least one of the light sensors 7A to 7E, a sensor signal is produced by at least one of the light sensors 7A to 7E and passed to the control device 8 via a connecting line, which is not illustrated in FIG. 1. The control device 8 immediately actuates the liquid-crystal film 3 such that it becomes non-see-through. Accordingly, the supply voltage to the liquid-crystal film 3 is switched off. Provision is additionally made even here for the alarm notification system (not illustrated), which is provided at the safety system 1, to be activated and for an alarm to be triggered.

Switching the liquid-crystal film 3 to a non-see-through state takes place for example even if for example a failure in the general supply of the liquid-crystal film 3 with voltage is detected at the control device 8. Consequently, for example in the case of a general power failure, the liquid-crystal film 3 is switched to a safety mode, specifically the second transparency state in which the liquid-crystal film 3 is non-see-through.

In an embodiment of the safety system 1, provision is additionally or alternatively made for the transparency of the liquid-crystal film 3 to be able to be brought into a desired state, for example the above-mentioned first transparency state or the above-mentioned second transparency state, by way of operating the control device 8. In other words, the control device 8 has an input device with which a desired transparency state of the liquid-crystal film 3 is settable. This is advantageous in particular if a user wishes not to be disturbed and/or intends to block the view into a space from the start.

FIG. 2 shows a schematic illustration of a second embodiment of the safety system 1 according to the invention. The safety system 1 according to FIG. 2 separates an exterior region 100 from an interior space 200. The interior space 200, for example, is a space of a building or of a transport means. The transport means is in particular embodied as a motor vehicle, as an aircraft or as a ship.

The safety system 1 has a first laminated safety glass device 20, which has a first glass pane 21 and a second glass pane 22. The first glass pane 21 and the second glass pane 22 are formed from glass. Alternatively or additionally, the first glass pane 21 and/or the second glass pane 22 can be made from plastics, for example from plexiglass. Arranged between the first glass pane 21 and the second glass pane 22 is a film unit 24. The film unit 24 is made, for example, from PVB and/or ionoplast. However, reference is explicitly made to the fact that the invention is not limited to these types of film unit 24. Rather, the invention allows the use of any film unit that is suitable for the invention. For example, the film unit 24 can also be made of ethylene vinyl acetate.

In a further form of the exemplary embodiment of FIG. 2, provision is additionally or alternatively made for the film unit 24 to be embodied as a film of a thermoplastic, for example in the form of an ionoplast, between the first glass pane 21 and the second glass pane 22, wherein the film is sold, for example, under the trademark SENTRYGLAS by the company DuPont. This film is considerably stronger and stiffer than other films (for example those made of polyvinyl butyral or ethylene vinyl acetate). Using this film therefore allows the use of such glass panes for the laminated safety glass device 20 that are thinner and consequently also more lightweight as compared to other exemplary embodiments, but which nevertheless render the laminated safety glass device 20 sufficiently bullet-proof, impact-resistant and/or resistant to explosion effects.

Arranged on the film unit 24 is a sensor unit for example in the form of an electrical conductor loop 4 and/or a shock sensor 5. The electrical conductor loop 4 is connected to a control device 8 via a first connecting line 9. The shock sensor 5 is connected to the control device 8 via a second connecting line 10.

The safety system 1 also has a second laminated safety glass device 25, which is separated from the first laminated safety glass device 20 by an intermediate space 23 by being arranged at a distance therefrom. The intermediate space 23 is defined by at least one spacer 37. The intermediate space 23 can be filled, for example, with a gas for thermal insulation. The second laminated safety glass device 25 has a first glass element 26 and a second glass element 27. Both the first glass element 26 and the second glass element 27 are embodied in the form of a toughened safety glass. Alternatively or additionally, the first glass element 26 and/or the second glass element 27 can be made from plastics, for example plexiglass.

Arranged between the first glass element 26 and the second glass element 27 is a liquid-crystal film 3. The liquid-crystal film 3 in the embodiment of the safety system 1 illustrated here is arranged both directly on the first glass element 26 and directly on the second glass element 27. In other embodiments, a first film unit is arranged between the first glass element 26 and the liquid-crystal film 3. In this other embodiment, a second film unit is additionally arranged between the second glass element 27 and the liquid-crystal film 3. The first film unit and/or the second film unit is/are formed, for example, from PVB. The liquid-crystal film 3 is connected to the control device 8 via a third connecting line 11. The control device 8 is provided for supplying the liquid-crystal film 3 with a supply voltage, wherein the supply voltage is used for the alignment of the liquid crystals.

Light rays that are incident on the first laminated safety glass device 20 transmit through the first laminated safety glass device 20 and through the liquid-crystal film 3. In other words, first arranged in a light incidence direction E is the first laminated safety glass device 20 and then the second laminated safety glass device 25 with the liquid-crystal film 3.

The liquid-crystal film 3 also has a settable transparency in the embodiment of the safety system 1 that is illustrated in FIG. 2. By way of example, the liquid-crystal film 3 can adopt a first transparency state and a second transparency state. In the first transparency state, the liquid-crystal film 3 is, for example, transparent or nearly transparent. In the second transparency state, the liquid-crystal film 3 is, for example, non-see-through.

In the embodiment of the safety system 1 according to the invention that is illustrated in FIG. 2, the transparency states are also actuated via the control device 8. By applying a voltage to the liquid-crystal film 3, poles of liquid crystals of the liquid-crystal film 3 align such that the liquid-crystal film 3 becomes transparent and thus adopts the first transparency state. If no voltage is applied, the liquid crystals have a random orientation. Light that is incident in the liquid-crystal film 3 is therefore strongly diffused. The liquid-crystal film 3 then becomes opaque. Accordingly, it is non-see-through, that is to say non-transparent. This is the second transparency state.

In the embodiment of the safety system 1 according to the invention that is illustrated in FIG. 2, the electrical conductor loop 4 is also embodied as a thin wire. It has the shape of a spider's web. Current flows through the electrical conductor loop 4. If the first glass pane 21 and/or the second glass pane 22 of the first laminated safety glass device 20 is/are destroyed by the impact of a force on the first laminated safety glass device 20 (for example on the first glass pane 21) (for example due to bullets and/or shrapnel from an explosion), the electrical conductor loop is destroyed and the circuit is interrupted. The interruption of the circuit is detected by the control device 8 via the first connecting line 9. The control device 8 actuates the liquid-crystal film 3 such that the liquid-crystal film 3 becomes non-see-through. Accordingly, the voltage that has been applied to the liquid-crystal film 3 is switched off. Provision is additionally made in this embodiment for an alarm notification system (not illustrated), which is provided at the safety system 1, to be activated and for an alarm to be triggered.

As mentioned above, the embodiment of FIG. 2 can additionally or alternatively have the shock sensor 5. The shock sensor 5 is embodied for example as an acceleration sensor. If force acts on the first laminated safety glass device 20, in particular on the first glass pane 21 (for example due to being shot at with a bullet and/or due to shrapnel from an explosion), the shock sensor 5 detects this impact and produces a corresponding sensor signal, which it passes on to the control device 8 via the second connecting line 10. The control device 8 in turn actuates the liquid-crystal film 3 such that the liquid-crystal film 3 becomes non-see-through. Accordingly, the voltage for supplying the liquid-crystal film 3 is switched off. Provision is additionally made in this embodiment for an alarm notification system (not illustrated), which is provided at the safety system 1, to be activated and for an alarm to be triggered.

Switching the liquid-crystal film 3 to a non-see-through state also takes place if, for example, a failure in the general supply of the liquid-crystal film 3 with voltage is detected at the control device 8. Consequently, for example in the case of a general power failure, the liquid-crystal film 3 is switched to a safety mode, specifically the second transparency state in which the liquid-crystal film 3 is non-see-through. In another embodiment of the safety system 1, provision is additionally or alternatively made for the transparency of the liquid-crystal film 3 to be able to be brought into a desired state, for example the above-mentioned first transparency state or the above-mentioned second transparency state, by way of operating the control device 8. In other words, the control device 8 has an input device with which a desired transparency state of the liquid-crystal film 3 is settable. This is advantageous in particular if a user wishes not to be disturbed and/or intends to block the view into a space from the start.

FIG. 3 shows a schematic illustration in the form of a sectional view of part of a third embodiment of the safety system 1 according to the invention. The safety system 1 according to FIG. 3 separates an exterior region 100 from an interior space 200. The interior space 200, for example, is a space of a building or of a transport means. The transport means is in particular embodied as a motor vehicle, as an aircraft or as a ship.

The safety system 1 has a first laminated safety glass device 20, which has a first glass pane 21, a second glass pane 22 and a third glass pane 28. The first glass pane 21, the second glass pane 22 and the third glass pane 28 are formed from glass. Alternatively or additionally, the first glass pane 21, the second glass pane 22 and/or the third glass pane 28 can be made from plastics, for example from plexiglass.

Arranged between the first glass pane 21 and the second glass pane 22 is a first film unit 29. The first film unit 29 is made, for example, from PVB and/or ionoplast. However, reference is explicitly made to the fact that the invention is not limited to this type of first film unit 29. Rather, the invention allows the use of any film unit that is suitable for the invention. For example, the first film unit 29 can also be made of ethylene vinyl acetate.

Arranged between the second glass pane 22 and the third glass pane 28 is a second film unit 30. The second film unit 30 has four films in total, specifically a first film 31, a second film 32, a third film 33 and a fourth film 34. At least one of the films 31 to 34 is made from PVB and/or ionoplast. Reference is again explicitly made to the fact that the invention is not limited to this type of films 31 to 34. Rather, the invention allows the use of any films 31 to 34 that are suitable for the invention. For example, the films 31 to 34 can also be made of ethylene vinyl acetate.

The first glass pane 21 and the second glass pane 22 can be formed for example from toughened safety glass. The third glass pane 28 can be made from float glass, for example.

In a further form of the exemplary embodiment of FIG. 3, provision is additionally or alternatively made for the first film unit 29 and/or the second film unit 30 (more specifically at least one or all of films 31 to 34) to be embodied as a thermoplastic, for example in the form of an ionoplast, wherein the first film unit 29 and/or the second film unit 30 (i.e. films 31 to 34) is/are sold, for example, under the trademark SENTRYGLAS by the company DuPont. Such film units are considerably stronger and stiffer than other films (for example those made of polyvinyl butyral or ethylene vinyl acetate). Using such film units therefore allows the use of such glass panes for the laminated safety glass device 20 that are thinner and consequently also more lightweight as compared to other exemplary embodiments, but which nevertheless render the laminated safety glass device 20 sufficiently bullet-proof, impact-resistant and/or resistant to explosion effects.

Arranged on the first film unit 29 is a sensor unit for example in the form of an electrical conductor loop 4 and/or a shock sensor 5. The electrical conductor loop 4 is connected to a control device 8 via a first connecting line 9. The shock sensor 5 is connected to the control device 8 via a second connecting line 10.

The safety system 1 also has a second laminated safety glass device 25, which is separated from the first laminated safety glass device 20 by an intermediate space 23 by being arranged at a distance therefrom. The intermediate space 23 is defined by at least one spacer and separates the third glass pane 28 of the first laminated safety glass device 20 from a first glass element 26 of the second laminated safety glass device 25. The intermediate space 23 is filled, for example, with a gas for thermal insulation. The second laminated safety glass device 25 moreover has a second glass element 27. Both the first glass element 26 and the second glass element 27 of the second laminated safety glass device 25 are embodied in the form of a toughened safety glass. Alternatively or additionally, the first glass element 26 and/or the second glass element 27 can be made from plastics, for example plexiglass.

Arranged between the first glass element 26 and the second glass element 27 is a liquid-crystal film 3. To be precise, a first film element 35 is additionally arranged between the first glass element 26 and the liquid-crystal film 3. A second film element 36 is additionally arranged between the second glass element 27 and the liquid-crystal film 3. The first film element 35 and/or the second film element 36 is/are formed, for example, from PVB. The liquid-crystal film 3 is connected to the control device 8 via a third connecting line 11. The control device 8 is provided for supplying the liquid-crystal film 3 with a supply voltage, wherein the supply voltage is used for the alignment of the liquid crystals.

Light rays that are incident on the first laminated safety glass device 20 transmit through the first laminated safety glass device 20 and through the liquid-crystal film 3. In other words, first arranged in a light incidence direction E is the first laminated safety glass device 20 and then the second laminated safety glass device 25 with the liquid-crystal film 3.

The liquid-crystal film 3 also has a settable transparency in the embodiment of the safety system 1 that is illustrated in FIG. 3. By way of example, the liquid-crystal film 3 can adopt a first transparency state and a second transparency state. In the first transparency state, the liquid-crystal film 3 is, for example, transparent or nearly transparent. In the second transparency state, the liquid-crystal film 3 is, for example, non-see-through.

In the embodiment of the safety system 1 according to the invention that is illustrated in FIG. 3, the transparency states are also actuated via the control device 8. By applying a voltage to the liquid-crystal film 3, poles of liquid crystals of the liquid-crystal film 3 align such that the liquid-crystal film 3 becomes transparent and thus adopts the first transparency state. If no voltage is applied, the liquid crystals have a random orientation. Light that is incident in the liquid-crystal film 3 is therefore strongly diffused. The liquid-crystal film 3 then becomes opaque.

Accordingly, it is non-see-through, that is to say non-transparent. This is the second transparency state.

In the embodiment of the safety system 1 according to the invention that is illustrated in FIG. 3, the electrical conductor loop 4 is also embodied as a thin wire. It has the shape of a spider's web. Current flows through the electrical conductor loop 4. If the first glass pane 21 and/or the second glass pane 22 of the first laminated safety glass device 20 is/are destroyed by the impact of a force on the first laminated safety glass device 20 (for example on the first glass pane 21) (for example due to bullets and/or shrapnel from an explosion), the electrical conductor loop is destroyed and the circuit is interrupted. The interruption of the circuit is detected by the control device 8 via the first connecting line 9. The control device 8 actuates the liquid-crystal film 3 such that the liquid-crystal film 3 becomes non-see-through. Accordingly, the voltage that has been applied to the liquid-crystal film 3 is switched off. Provision is additionally made in this embodiment for an alarm notification system (not illustrated), which is provided at the safety system 1, to be activated and for an alarm to be triggered.

As mentioned above, in the embodiment of FIG. 3, provision is additionally or alternatively made for the shock sensor 5 to be used. The shock sensor 5 is embodied for example as an acceleration sensor. If force acts on the first laminated safety glass device 20, in particular on the first glass pane 21 (for example due to being shot at with a bullet and/or due to shrapnel from an explosion), the shock sensor 5 detects this impact and produces a corresponding sensor signal, which it passes on to the control device 8 via the second connecting line 10. The control device 8 in turn actuates the liquid-crystal film 3 such that the liquid-crystal film 3 becomes non-see-through. Accordingly, the voltage for supplying the liquid-crystal film 3 is switched off. Provision is additionally made in this embodiment for an alarm notification system (not illustrated), which is provided at the safety system 1, to be activated and for an alarm to be triggered.

In the exemplary embodiment according to FIG. 3, switching the liquid-crystal film 3 to a non-see-through state can also take place if, for example, a failure in the general supply of the liquid-crystal film 3 with voltage is detected at the control device 8. Consequently, for example in the case of a general power failure, the liquid-crystal film 3 is switched to a safety mode, specifically the second transparency state in which the liquid-crystal film 3 is non-see-through.

In another embodiment of the safety system 1, provision is additionally or alternatively made for the transparency of the liquid-crystal film 3 to be able to be brought into a desired state, for example the above-mentioned first transparency state or the above-mentioned second transparency state, by way of operating the control device 8. In other words, the control device 8 has an input device with which a desired transparency state of the liquid-crystal film 3 is settable. This is advantageous in particular if a user wishes not to be disturbed and/or intends to block the view into a space from the start.

FIG. 4 shows a flowchart of a method according to the invention. The method according to the invention makes provision in a method step S1 for a property to be detected by the sensor unit. Exemplary embodiments of the sensor unit have been discussed in detail further above. The detected property is for example a shock, a destruction of the transparent pane device 2, destruction of the glass panes 21, 22 and/or 28 of the first laminated glass safety device 20 and/or incidence of light on the transparent pane device 2 or the first laminated safety glass device 20 from a laser measuring device or a laser targeting device. If this property is detected, a sensor signal is produced in a method step S2. The sensor signal is passed to the control device in a method step S3. The control device 8 sets the transparency of the liquid-crystal film 3 in dependence on the sensor signal in a method step S4. In other words, the control device 8 sets the transparency state of the liquid-crystal film 3. Provision is made in particular for the transparency to be set such that the liquid-crystal film 3 becomes non-see-through.

All exemplary embodiments of the safety system 1 according to the invention have the advantage that, when danger or imminent danger is ascertained by one of the previously described sensor units, a sensor signal can be emitted to the control device 8 such that the control device 8 actuates the liquid-crystal film 3 such that the liquid-crystal film 3 becomes non-see-through. Consequently, the view through the liquid-crystal film 3 into a space located behind the liquid-crystal film 3 (for example the interior space 200) and/or the view of an object that is situated behind the liquid-crystal film 3 is blocked. Third parties are consequently unable to view the object or the interior space 200. As a consequence, the safety for example of persons situated in the interior space 200 is increased. The invention is suitable in particular for protecting persons and objects against arms fire or explosion effects, in particular effects of shrapnel.

The features of the invention disclosed in the present description, in the drawings and in the claims can be essential individually and in any desired combinations for implementing the invention in its various embodiments. The invention is not limited to the embodiments described. It can be varied within the scope of the claims and taking into account the knowledge of a person skilled in the art.

### LIST OF REFERENCE SIGNS

1 safety system

2 transparent pane device

3 liquid-crystal film

4 electrical conductor loop

5 shock sensor

6 film

7A first light sensor

7B second light sensor

7C third light sensor

7D fourth light sensor

7E fifth light sensor

8 control device

9 first connecting line

10 second connecting line

11 third connecting line

20 first laminated safety glass device

21 first glass pane

22 second glass pane

23 intermediate space

24 film unit

25 second laminated safety glass device

26 first glass element

27 second glass element

28 third glass pane

29 first film unit

30 second film unit

31 first film

32 second film

33 third film

34 fourth film

35 first film element

36 second film element

37 spacer

100 exterior region

200 interior space

E light incidence direction

S1 to S4 method steps

1. A safety system (1), having
at least one transparent pane device (2, 20, 25), wherein the transparent pane device (2, 20) is embodied to be bullet-proof, impact-resistant and/or resistant to explosion effects,
at least one liquid-crystal film (3) having a settable transparency, wherein the liquid-crystal film (3) is arranged at the transparent pane device (2, 20, 25) and/or at a distance from the transparent pane device (2, 20, 25), wherein light rays that are incident on the transparent pane device (2, 20, 25) transmit through the transparent pane device (2, 20, 25) and through the liquid-crystal film (3),
at least one sensor unit (4, 5, 7A to 7E) for emitting a sensor signal, wherein the sensor unit (4, 5, 7A to 7E) is arranged at the transparent pane device (2, 20), and having
at least one control device (8) for setting the transparency of the liquid-crystal film (4) in dependence on the sensor signal.

2. The safety system (1) as claimed in claim 1, wherein the sensor unit (4, 5, 7A to 7E) comprises at least on electrical conductor loop.

3. The safety system (1) as claimed in claim 1, wherein the sensor unit (4, 5, 7A to 7E) comprises at least one light sensor.

4. The safety system (1) as claimed in claim 3, wherein the light sensor (7A to 7E) is embodied as a CCD sensor, as a photodiode, as a phototransistor or as a photoresistor.

5. The safety system (1) as claimed in claim 1, claims, wherein the sensor unit (4, 5, 7A to 7E) comprises at least one shock sensor (5).

6. The safety system (1) as claimed in claim 5, wherein the shock sensor (5) is embodied as an acceleration sensor.

7. The safety system (1) as claimed in claim 1, wherein the safety system (1) has one of the following features:
(i) the transparent pane device (2, 20, 25) is formed in part from glass;
(ii) the transparent pane device (2, 20, 25) is formed entirely from glass;
(iii) the transparent pane device (2, 20, 25) is formed in part from plastics;
(iv) the transparent pane device (2, 20, 25) is formed entirely from plastics.

8. The safety system (1) as claimed in claim 1, wherein the transparent pane device (20, 25) includes a laminated safety glass, which comprises a first glass pane (21, 26) and a second glass pane (22, 27), wherein at least one film unit (24) made of polyvinyl butyral and/or ionoplast is arranged between the first glass pane (21, 26) and the second glass pane (22, 27).

9. The safety system (1) as claimed in claim 8, wherein the film unit (24) has between the first glass pane (21, 26) and the second glass pane (22, 27) at least one intermediate layer of the trademark SENTRYGLAS.

10. The safety system (1) as claimed in claim 1, wherein
the transparent pane device (20, 25) includes a laminated safety glass device (25),
the laminated safety glass device (20) comprises at least one first glass pane (21), at least one second glass pane (22) and at least one third glass pane (28),
arranged between the first glass pane (21) and the second glass pane (22) is at least one first film unit (29) made of polyvinyl butyral and/or ionoplast, and wherein
arranged between the second glass pane (22) and the third glass pane (28) is at least one second film unit (30) made of polyvinyl butyral and/or ionoplast.

11. The safety system (1) as claimed in claim 10, wherein the first film unit (29) and/or the second film unit (30) has at least one intermediate layer of the trademark SENTRYGLAS.

12. The safety system (1) as claimed in claim 10 or 11, wherein the second film unit (30) has one of the following features:
(i) the second film unit (30) comprises at least two films (31 to 34) which are arranged parallel with respect to one another;
(ii) the second film unit (30) comprises at least four films (31 to 34) which are arranged parallel with respect to one another;
(iii) the second film unit (30) comprises at least six films (31 to 34) which are arranged parallel with respect to one another.

13. The safety system (1) as claimed in claim 1, wherein
the control device (8) has a first switch state and a second switch state,
the sensor unit (4, 5, 7A to 7E) has at one switch output of the sensor unit (4, 5, 7A to 7E) a first sensor signal for the first switch state or a second sensor signal for the second switch state, and wherein
the liquid-crystal film (3) in the second switch state is embodied to be non-see-through.

14. A safety system (1), having
at least one transparent pane device (2, 20, 25),
at least one liquid-crystal film (3) having a settable transparency, wherein the liquid-crystal film (3) is arranged at the transparent pane device (2, 20, 25) and/or at a distance from the transparent pane device (2, 20, 25), wherein light rays that are incident on the transparent pane device (2, 20, 25) transmit through the transparent pane device (2, 20, 25) and through the liquid-crystal film (3),
at least one sensor unit (4, 5, 7A to 7E) for emitting a sensor signal, wherein the sensor unit (4, 5, 7A to 7E) is arranged at the transparent pane device (2, 20), and having
at least one control device (8) for setting the transparency of the liquid-crystal film (3) in dependence on the sensor signal.

15. A method for securing a space (200) using a safety system (1) as claimed in claim 1, wherein the method has the following steps:
detecting a property by the sensor unit (4, 5, 7A to 7E);
producing a sensor signal;
passing the sensor signal to the control device (8); and
setting the transparency of the liquid-crystal film (3) by way of the control device (8) in dependence on the sensor signal.

16. The method as claimed in claim 15, wherein the transparency is set such that the liquid-crystal film (3) is non-see-through.

17. A method for securing a space (200) using a safety system (1) as claimed in claim 14, wherein the method has the following steps:
detecting a property by the sensor unit (4, 5, 7A to 7E);
producing a sensor signal;
passing the sensor signal to the control device (8); and
setting the transparency of the liquid-crystal film (3) by way of the control device (8) in dependence on the sensor signal.

18. The method as claimed in claim 17, wherein the transparency is set such that the liquid-crystal film (3) is non-see-through.
